(19) United States
(12) Patent Application Publication
(10) Pub. No.: US 2012/0301080 A1
(43) Pub. Date: Nov. 29, 2012

(54) TRUE ONE PIECE HOUSING FIBER OPTIC ADAPTER

(75) Inventor: Jeffrey Gniadek, Northbridge, MA (US)

(73) Assignee: SENKO ADVANCED COMPONENTS, INC., Marlboro, MA (US)

(21) Appl. No.: 13/113,635

(22) Filed: May 23, 2011

(51) Int. Cl. G02B 6/38

(52) U.S. Cl. 385/56

(57) ABSTRACT

A fiber optic adapter includes a one piece housing, a dual connector latch, and an alignment sleeve. The one piece housing includes a first alignment cylinder configured to receive a first optic fiber and at least one snap receiving recess. The dual connector latch includes a second alignment cylinder configured to receive a second optic fiber and at least one snap feature configured to engage within the snap receiving recess such that the connector latch locks within the housing. The alignment sleeve is configured to be placed within the first alignment cylinder and the second alignment cylinder such that the alignment sleeve

### BACKGROUND

The present disclosure relates to an adapter or a coupling for holding two fiber optic connectors in alignment. More specifically, the present disclosure relates to an adapter or coupling having a one piece, unibody housing.

Recently, the use of fiber optics for communications purposes has grown immensely. Data, voice, and other communication networks are increasingly using fiber optics to carry information. An optical fiber is generally a glass fiber configured to carry light. Individual fibers may be grouped into a line capable of carrying large amounts of data simultaneously.

When constructing a fiber optic network, each individual fiber is generally connected to both a source and a destination device. Additionally, along the fiber optic run between the source and the destination, various connections or couplings may be made on the optical fiber to adjust the length of the fiber. Each connection or coupling requires a connector and adapter to align the fibers such that the light can transmit without interruption. A typical connector includes two symmetrical housings, each housing having a connector latch. An alignment sleeve is placed within the connector latches to ensure the fibers are properly aligned. Then, the two housings are welded (i.e., via ultrasonic welding), riveted, or otherwise attached to each other, thereby forming a coupling. Individual optic fibers are then places within each connector latch, the alignment sleeve aligning the fibers.

This exemplary coupling is expensive to produce as numerous parts are required (each of which may require separate manufacturing), and a welding, riveting or other attachment process must be done to connect the two symmetrical housings. Additionally, alignment issues may result from the attachment process as the two symmetrical housing components may shift during welding.

One approach to reduce the amount of components required is shown in U.S. Pat. No. 5,317,663 (the '663 patent), issued May 31, 1994 to Beard et al, the contents of which are incorporated herein by reference. In the '663 patent, an adapter is taught which includes a single piece housing in which both connector latches are placed, along with n alignment sleeve, to provide an adapter. However, to place the components within the housing, a window is provided in the housing. A housing cover is provided which is welded to the housing to cover the window. While the design of the '663 patent may eliminate any issues with alignment resulting from the attachment of the two housing components, it still requires numerous components and multiple assembly steps including welding the housing cover over the window.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In one general respect, the embodiments disclose a fiber optic adapter. The fiber optic adapter includes a one piece housing, a dual connector latch, and an alignment sleeve. The one piece housing includes a first alignment cylinder configured to receive a first optic fiber and at least one snap receiving recess. The dual connector latch includes a second alignment cylinder configured to receive a second optic fiber and at least one snap feature configured to engage within the snap receiving recess such that the connector latch locks within the housing. The alignment sleeve is configured to be placed within the first alignment cylinder and the second alignment cylinder such that the alignment sleeve is positioned prior to the dual connector latch being locked into the housing.

In another general respect, the embodiments disclose an alternative fiber optic adapter. The fiber optic adapter includes a one piece housing comprising a first alignment cylinder configured to receive a first optic fiber, a dual connector latch comprising a second alignment cylinder configured to receive a second optic fiber, and an alignment sleeve configured to be placed within the first alignment cylinder and the second alignment cylinder, wherein the alignment sleeve is positioned prior to the dual connector latch being locked into the housing.

### BRIEF DESCRIPTION OF THE DRAWINGS

FIG. 1 illustrates an exemplary fiber optic adapter including a one piece housing according to an embodiment.

FIG. 2 illustrates an exploded view of the fiber optic adapter of FIG. 1.

FIG. 3a illustrates a cross-sectional view of the one piece housing of FIG. 1.

FIG. 3b illustrates a cross-sectional view of the fiber optic adapter of FIG. 1.

### DETAILED DESCRIPTION

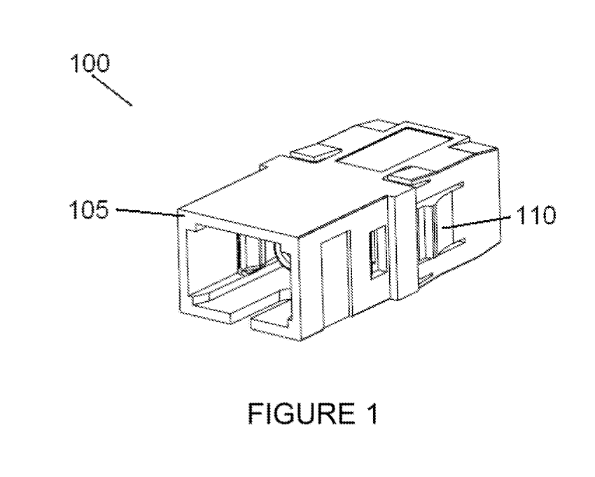

FIG. 1 illustrates an exemplary fiber optic connector or adapter 100 including a one piece housing 105. The housing 105 may be made from a plastic or polymer via various manufacturing methods. For example, the housing 105 may be made from an injection molded polymer. The housing 105 may include various external features such as one or more integral bulkhead latches 110 for latching the housing (and thus the adapter 100) to another device such as the input port on a network router.

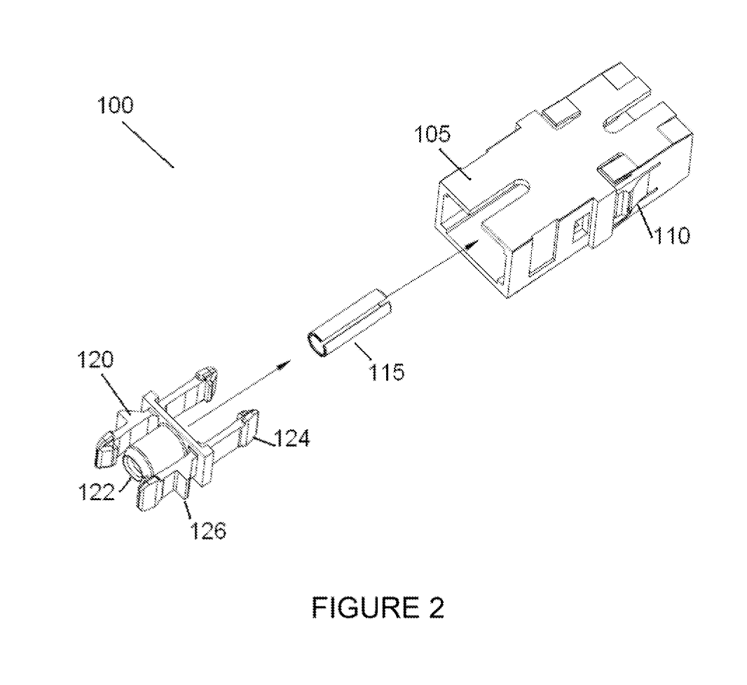

FIG. 2 illustrates an exploded view of adapter 100. In this exemplary embodiment, the adapter 100 includes three major components: (1) the single piece housing 105, (2) an alignment sleeve 115, and (3) a dual connector latch 120. The dual connector latch may include several components such as an alignment cylinder 122 for receiving a first topic fiber, retaining clips 124 configured to frictionally hold or engage a fiber optic tip enclosure, and one or more snap features 126. As shown in FIG. 2, two sets of retaining clips 124 are integrated into the dual connector latch 120, a first set for engaging a first optic fiber and a second set for engaging a second optic fiber. An optic fiber is typically terminated in a grip housing including notches for engaging with the retaining clips 124. Within each grip housing is an end of the optic fiber including a ferrule and a ferrule holder. However, manufacture of optic fibers, including terminations and associated housings is well known in the art and will not be discussed in additional detail. As also shown in FIG. 2, the snap features 126 are small, integral protrusions positioned and shaped to frictional hold or engage one or more snap receiving recesses within the housing 105. Similar to the housing 105, the dual connector latch 120 may be manufactured as a single injection molded component.

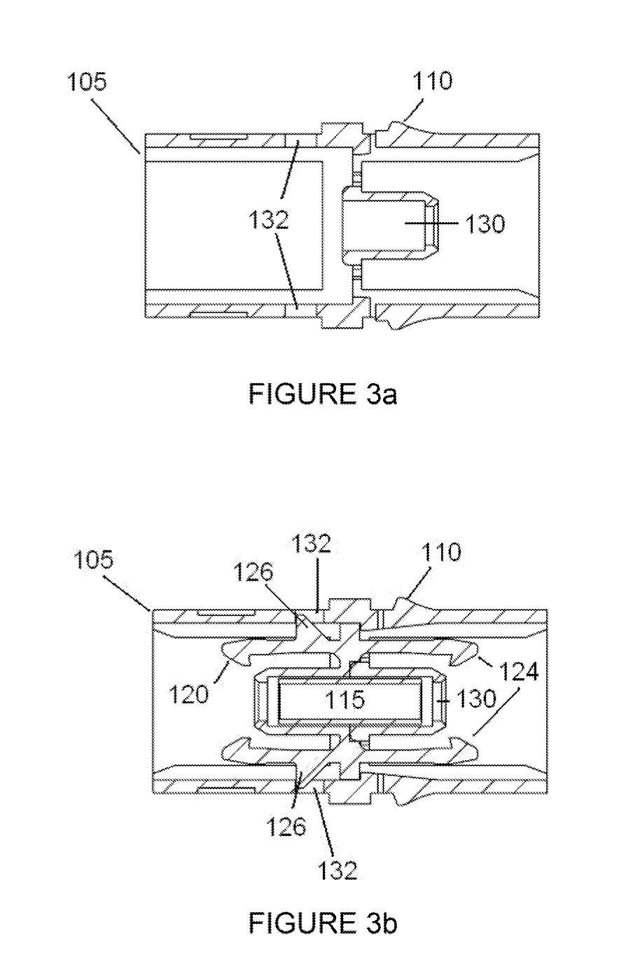

FIG. 3a illustrates a cross-sectional view of the housing 105. The housing 105 may include several features such as an integral alignment cylinder 130 (similar to alignment cylinder 122 of the dual connector latch 120) configured to frictionally hold an optic fiber. The integral alignment cylinder 130 may be formed along with the housing 105 during a single injection molding process. The housing 105 may also include one or more snap receiving recesses 132. The snap receiving recesses 132 may be positioned and sized to accept the snap features 126 of the dual connector latch 120. In this example, the snap receiving recesses 132 are indentations in the sidewall of the housing 105 such that, when pushed into the housing, the snap features 126 of the dual connector latch 120 grab against the receiving recesses, thereby locking the dual connector latch into the housing.

FIG. 3b illustrates a cross sectional view of adapter 100 after the alignment sleeve 115 and the dual connector latch 120 have been assembled within the housing 105. As shown in FIG. 3b, the snap features 126 of the dual connector latch 120 are positioned within the snap receiving recess 132, thereby locking the dual connector latch within the housing. Similarly, a set of retaining clips 124 of the dual connecting latch 120 are positioned about the integral alignment cylinder 130 such that any optic fiber placed into the integral alignment cylinder will be held in place by the retaining clips.

Referring again to FIG. 2, to assemble the adapter 100, the alignment sleeve 115 is positioned such that it is aligned with both the alignment cylinder 122 of the dual connector latch 120, as well as the alignment cylinder 130 of the housing 105. After aligning, the dual connector latch 120 is placed within the housing 105 and a force is applied on the dual connector latch until the snap feature 126 locks into the snap receiving recess 132 of the housing. Once the snap feature 126 is locked, assembly of the adapter 100 is complete. In this configuration, only 3 components are required and no assembly techniques beyond the application of a pushing force is required.

The one piece adapter housing as taught herein eliminates the need to ultrasonically weld the components together as is required by the prior art. This reduces the cost of manufacturing and assembling additional components. Additionally, depending on the design of the snap features and associated snap receiving recesses, the adapter may be disassembled to replace a worn part (e.g., if a retaining clip on the dual latch connector breaks) or otherwise repair the adapter. This feature would not be possible in the prior art as the adapters are permanently welded into a solid piece.

The various components described above may be constructed by manufacturing methods well know in the art. Materials for use in construction of the various components listed above may include various polymers, plastics, metals, glass, and other similar suitable materials. For example, the housing 105 may be manufactured via an plastic injection molding process. Alternatively, the housing 105 may be manufactured from a suitable metal via a milling process. Additional materials and manufacturing methods will be well known to those skilled in the art.

The above examples are not intended to limit the invention, but merely to serve as an illustration of how the invention might be constructed and operated.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A fiber optic adapter comprising:
a one piece housing comprising
a first alignment cylinder configured to receive a first optic fiber, and
at least one snap receiving recess;
a dual connector latch comprising:
a second alignment cylinder configured to receive a second optic fiber, and
at least one snap feature configured to engage within the snap receiving recess
such that the connector latch locks within the housing; and
an alignment sleeve configured to be placed within the first alignment cylinder and the second alignment cylinder, wherein the alignment sleeve is positioned prior to the dual connector latch being locked into the housing.

2. The fiber optic adapter of claim 1, wherein the first alignment cylinder is integral to the housing.

3. The fiber optic adapter of claim 1, wherein the at least one snap receiving recess is an indentation in a sidewall of the housing.

4. The fiber optic adapter of claim 3, wherein the at least one snap feature is a protrusion from the dual connector latch corresponding to the indentation in the sidewall of the housing.

5. The fiber optic adapter of claim 1, wherein the housing is a single injection-molded component.

6. The fiber optic adapter of claim 1 wherein the dual connector latch is a single injection molded component.

7. The fiber optic adapter of claim 1, wherein the dual connector latch further comprises:
a first set of retaining clips for engaging a first optic fiber; and
a second set of retaining clips for engaging a second optic fiber.

8. A fiber optic adapter comprising:
a one piece housing comprising a first alignment cylinder configured to receive a first optic fiber;
a dual connector latch comprising a second alignment cylinder configured to receive a second optic fiber; and
an alignment sleeve configured to be placed within the first alignment cylinder and the second alignment cylinder, wherein the alignment sleeve is positioned prior to the dual connector latch being locked into the housing.

9. The fiber optic adapter of claim 8, wherein the housing further comprises at least one snap receiving recess.

10. The fiber optic adapter of claim 9, wherein the dual connector latch further comprises at least one snap feature configured to engage within the snap receiving recess such that the connector latch locks within the housing.

11. The fiber optic adapter of claim 8, wherein the first alignment cylinder is integral to the housing.

12. The fiber optic adapter of claim 8, wherein the at least one snap receiving recess is an indentation in a sidewall of the housing.

13. The fiber optic adapter of claim 12, wherein the at least one snap feature is a protrusion from the dual connector latch corresponding to the indentation in the sidewall of the housing.

14. The fiber optic adapter of claim 8, wherein the housing is a single injection-molded component.

15. The fiber optic adapter of claim 8 wherein the dual connector latch is a single injection molded component.

16. The fiber optic adapter of claim 8, wherein the dual connector latch further comprises:
a first set of retaining clips for engaging a first optic fiber; and
a second set of retaining clips for engaging a second optic fiber.
